(19) United States
(12) Patent Application Publication
(10) Pub. No.: US 2023/0320456 A1
(43) Pub. Date: Oct. 12, 2023

(54) WEARABLE INFORMATION DISPLAY

(71) Applicant: R&S MERCHANDISE LLC, Houston, TX (US)

(72) Inventor: Ronald Santiago, Houston, TX (US)

(73) Assignee: R&S MERCHANDISE LLC, Houston, TX (US)

(21) Appl. No.: 18/133,130

(22) Filed: Apr. 11, 2023

Related U.S. Application Data
(60) Provisional application No. 63/329,832, filed on Apr. 11, 2022.

(51) Int. Cl. A43B 3/34; G06F 1/16

(52) U.S. Cl. CPC A43B 3/34; G06F 1/1652

(57) ABSTRACT

A wearable display device and system are provided. The wearable display device may include a shoe having a display screen installed therein. The wearable display device may further include a processor, which includes a memory, which provides instructions to the display screen to display a user provided message. The system may include a shoe having a display screen installed therein. The wearable display device may further include a processor, which includes a memory, which provides instructions to the display screen to display a user provided message. The system may further comprise a user device connectable to the wearable display device through wired or wireless connections.

### PRIORITY CLAIM

This application claims the priority to and benefit of U.S. Provisional Patent Application 63/329,832 filed on Apr. 11, 2022 which is incorporated herein by reference in its entirety, including, but not limited to those portions that specifically appear hereinafter, the incorporation by reference being made with the following exception: In the event that any portion of the above-referenced provisional application is inconsistent with this application, the application supersedes the above-referenced provisional application.

### BACKGROUND

### 1. Technical Field

This disclosure relates generally to wearable information displays. In one example, a wearable information display may be a wearable digital display meant to convey a message from the wearer to other people in general or to a specific person or persons.

### 2. Description of the Related Art

Among the earliest known footwear are sandals made from sagebrush bark. Other early footwear developments include shoes made of leather, for example a single piece of cowhide laced with a leather cord. Many of the earliest footwear designs were little more than bags for covering the feet. Later, tighter fitting footwear, such as leather moccasins, were developed. Such early footwear was often worn intermittently as it was not suited to wet weather or was not needed during the warmer months.

Thong sandals were developed by many early civilizations, which include, for example the Egyptians, the Masai, the Chinese, the Japanese, and the natives of Mexico. A variety of materials were used for constructing these sandals such as papyrus and palm leaves, rawhide, wood, rice straw, leaves of the sisal plant, and the yucca plant. Later shoe materials included fabrics and wood. Further developments included differentiation between shoes for the right and left feet and the addition of heels. Since the onset of the industrial era many advances have been made in footwear to include rubber, plastics, synthetic cloth, and industrial adhesives to make the wide variety of footwear with which we are familiar today.

To date footwear has been used to convey information only in a rudimentary fashion. Likely, the conveying of information using footwear began from ornamentation. Ornamentation of footwear began with some of the earliest developments such as moccasins in North America which were often decorated with beads and other adornments. In the modern era, ornamentation has been minimally used to convey information such as by use of a trademark through stitching, printed symbols, or logos attached by adhesives, for example. To date, footwear has not been used to convey changeable messages.

### SUMMARY

A wearable display device and system are provided. The wearable display device may include a shoe having a display screen installed therein. The wearable display device may further include a processor, which includes a memory, which provides instructions to the display screen to display a user provided message. The system may include a shoe having a display screen installed therein. The wearable display device may further include a processor, which includes a memory, which provides instructions to the display screen to display a user provided message. The system may further comprise a user device connectable to the wearable display device through wired or wireless connections.

### BRIEF DESCRIPTION OF THE DRAWINGS

The accompanying drawings illustrate various embodiments of the device and systems disclosed herein.

FIG. 1 illustrates a perspective view of an exemplary shoe with a display, according to an embodiment of the disclosure.

FIG. 2 illustrates a right profile of the shoe demonstrating the display in use, according to an embodiment of the disclosure.

FIG. 3 illustrates a left profile of the shoe demonstrating the display in use, according to an embodiment of the disclosure.

FIG. 4 illustrates a front view of the shoe demonstrating the display in use, according to an embodiment of the disclosure.

FIG. 5 illustrates a block diagram of a system of the shoe with the display and an exemplary user device, according to an embodiment of the disclosure.

### DETAILED DESCRIPTION OF PREFERRED EMBODIMENTS

In the following description, for purposes of explanation and not limitation, specific techniques and embodiments are set forth, such as particular techniques and configurations, in order to provide a thorough understanding of the device disclosed herein. While the techniques and embodiments will primarily be described in context with the accompanying drawings, those skilled in the art will further appreciate that the techniques and embodiments may also be practiced in other similar devices.

Reference will now be made in detail to the exemplary embodiments, examples of which are illustrated in the accompanying drawings. Wherever possible, the same reference numbers are used throughout the drawings to refer to the same or like parts. It is further noted that elements disclosed with respect to particular embodiments are not restricted to only those embodiments in which they are described. For example, an element described in reference to one embodiment or figure, may be alternatively included in another embodiment or figure regardless of whether or not those elements are shown or described in another embodiment or figure. In other words, elements in the figures may be interchangeable between various embodiments disclosed herein, whether shown or not.

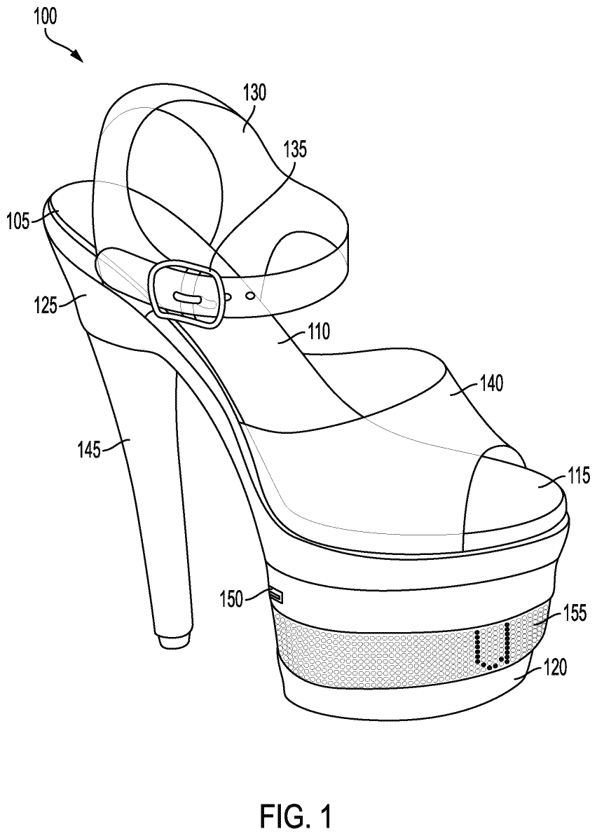

FIG. 1 illustrates a perspective view of an exemplary shoe 100 with display 155. Shoe 100, as shown in FIG. 1 is merely exemplary of one embodiment of this disclosure. The disclosure is not limited to any shoe of any particular style (e.g., a high heel) and may be used in connection with any shoe of any type.

In one embodiment, shoe 100 may be comprised of insole 125 having heel portion 105, mid portion 110, and toe portion 115. Heel portion 105, mid portion 110, and toe portion 115 may form a single piece with heel portion 105 adjacent to mid portion 110 and mid portion 110 adjacent to toe portion 115. Shoe 100 also may have sole 120 connected to toe portion 115 of insole 125 and heel 145 connected to heel portion 105 of insole 125. Shoe 100 may further comprise adjustable strap 130 connected to insole 125 at the junction of heel portion 105 and mid portion 110. Adjustable strap 130 may include a buckle 135 attached thereto for allowing adjustable strap 130 to be adjusted and fixed in place. Adjustable strap 130 with buckle 135 may allow a user to put on and remove shoe 100, as well as to adjust the fit of shoe 100 when in use by adjusting the tightness of adjustable strap 130. Shoe 100 may also comprise toe strap 140 which may be connected to shoe 100 at the junction of toe portion 115 and mid portion 110 of insole 125. Shoe 100 may further comprise display 155 which may be connected to, and form part of, sole 120. Shoe 100 may be further equipped with power port 150, which may be located on the back side of sole 120, to allow for connection of shoe 100 with a power and/or information source.

Shoe 100 may be comprised of any suitable material known to those of ordinary skill in the art with different components being comprised of different materials. Component materials may include, for example, leather, canvas, mesh, suede, faux suede, cotton, wool, silk, nylon, neoprene, lycra and other man-made textiles, synthetic leather, plastics, and other materials known to one of ordinary skill in the art. In one embodiment, for example, heel 145 may be made of wood, plastic, metal, bone, leather, or some combination thereof. Further, heel portion 105, mid portion 110 and toe portion 115 may be made from foam, gel, cork, leather, fabrics, or some combination thereof. Additionally, adjustable strap 130 and toe strap 140 may be made from plastic, leather, canvas, textiles, or some combination thereof. Different combinations of materials for different parts of shoe 100 will be apparent to one of ordinary skill in the art.

In some embodiments, shoe 100 may comprise additional or fewer components. For example, shoe 100 may have a more substantial upper than toe strap 140 and may also have a toebox. Additionally, adjustable strap 130 may be replaced with a counter. In some embodiments, shoe 100 may be a shoe with a single upper rather than an adjustable strap and a toe strap. In still other embodiments, sole 120 and heel 145 may comprise a single continuous component rather than being separate and distinct components. In some embodiments where the sole is a single continuous component, the back of the shoe, above the sole, may be referred to as the heel. Finally, all possible arrangements of different embodiments may not be enumerated herein, but will be apparent to one of ordinary skill in the art.

In some embodiments, shoe 100 may have a different arrangement of components with connections between components being placed in different locations or may have different proportions. For example, adjustable strap 130 may be moved backward or forward to connect with insole 125 at heel portion 105 or mid portion 110, respectively, rather than at junction of heel portion 105 and mid portion 110. Likewise, toe strap 140 may be moved forward or backward to attach to insole 125 at toe portion 115 or mid portion 110, respectively, rather than at junction of toe portion 115 and mid portion 110. Additionally, the length of heel 145 may be adjusted, or adjustable, thereby changing the pitch of shoe 100. Additionally, sole 120 may have a greater or lesser height or may be adjustable. Further, buckle 135 may be replaced with other means for allowing adjustable strap 130 to be adjusted and secured. Such means may include snaps, hook and loop, buttons, zippers, or any other means known to those of ordinary skill in the art. Display 155 may be of a variety of sizes and comprised of a variety of materials. For example, display 155 may have any height and may be up to a virtually complete loop around sole 120. Display 155 may also cover only a portion of sole 120, for example the left side, the back, the front, the right side or some combination thereof. Different sizes and arrangements of display 155 will be apparent to one of ordinary skill in the art.

Display 155 may be connected to and/or form part of different portions of shoe 100, for example the upper, the heel, or other parts that will be apparent to one of ordinary skill in the art. In some embodiments, display 155, may be connected to or form part of a portion or portions of the different parts of the shoe, for example, display 155 could form part of the back side of an upper (e.g., above the heel), a side of the upper, the tongue, the toe of the upper, or combinations of these portions. Other portions or combinations of portions of shoe 100 known to those of ordinary skill in the art may incorporate or be connectable to display 155.

Display 155 may be removable from shoe 100 and reconnectable thereto. For example, in some embodiments, display 155 may be removable from and connectable to an upper, and reconnected to a heel, the sole, or other parts of shoe 100. Interchangeable locations for display will be apparent to one of ordinary skill in the art.

In some embodiments, shoe 100 may contain multiple displays. In such embodiments displays may be placed on opposing sides of sole 120, such as the left and right sides or the front and back sides, or displays may be on adjacent sides of sole 120, for example on the left side and the front side of sole 120, on the right side and the front side of sole 120, on left, front and right sides of sole 120, or other combinations that will be apparent to one of ordinary skill in the art.

Display 155 may be made of a variety of components to customize the use of display 155, as will be discussed below. For example, display 155 may be made from waterproof or water-resistant components and installed in a water-sealed manner inside the shoe, to allow shoe 100 to be used outdoors or in wet conditions. Display 155 may be a flexible LED display, a flexible plasma screen, or other displays known to those of ordinary skill in the art. Display 155 may incorporate one or more types of light emitting diode (“LED”) displays, for example, solid state light, surface-emitting light, edge-lit light displays or other displays that may or may not use LED's which will be apparent to those of ordinary skill in the art. Display 155 may also be comprised of indoor, outdoor, or combination indoor and outdoor LED technology. Display 155 may be a single color, double primary color, three primary colors, or other color combinations as apparent to those of ordinary skill in the art. Display 155 may be designed to convey messages via video, text, image, digital, LED lattice image text or other display performance levels known to those of ordinary skill in the art. Display 155 may be synchronized or unsynchronized. Other components and uses will be apparent to those of ordinary skill in the art.

In one embodiment, display 155 may display video of any resolution or refresh rate known to those of ordinary skill in the art. For example, display 155 may be capable of displaying video with a resolution of any of the following: dot matrix, Standard Definition (480p), High Definition (720p) (“HD”), Full HD (1080p), Quad HD (1440p), 2K video (1080p), 4K video or Ultra HD (4K or 2160p), 8K video or Full Ultra HD (8K or 4320p) or other resolution known to those of ordinary skill in the art. Additionally, display 155 may be capable of any of the following refresh rates: 60 Hz, 90 Hz, 120 Hz, 144 Hz, 165 Hz, 240 Hz, or other refresh rate known to those having ordinary skill in the art.

Power port 150 of shoe 100 may be one of a variety of different power ports or shoe 100 may include one or more power ports of different sizes and connections. Additionally, power port 150 may be placed in a variety of locations within shoe 100. Power ports may include USB-A, USB-B, USB-C, a lightning port, Mini-A, Mini-B, Micro-A, Micro-B, or some combination thereof. Power port 150 may be placed in a variety of different locations such as at the back or bottom of sole 120, on either of the sides of sole 120, on heel 145, or other locations that will be apparent to one of ordinary skill in the art. Different arrangements and combinations of power port 150 will be apparent to one of ordinary skill in the art.

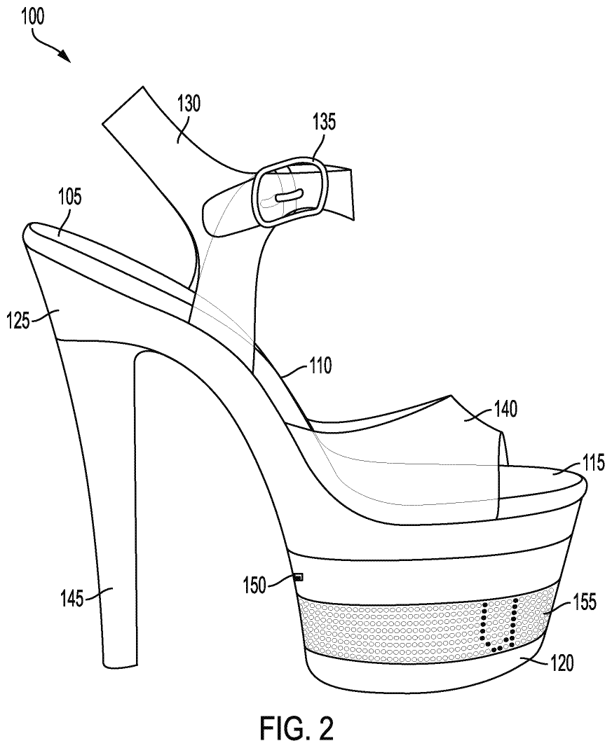

FIG. 2 illustrates a right profile of shoe 100 demonstrating display 155 in use. As discussed above, shoe 100 may be comprised of insole 125 having heel portion 105, mid portion 110, and toe portion 115. Heel portion 105, mid portion 110, and toe portion 115 may form a single piece with heel portion 105 adjacent to mid portion 110 and mid portion 110 adjacent to toe portion 115. Shoe 100 also may have sole 120 connected to toe portion 115 of insole 125 and heel 145 connected to heel portion 105 of insole 125. Shoe 100 may further comprise adjustable strap 130 connected to insole 125 at the junction of heel portion 105 and mid portion 110. Adjustable strap 130 may have buckle 135 attached thereto for allowing adjustable strap 130 to be adjusted and fixed in place. Adjustable strap 130 with buckle 135 may allow a user to put on and remove shoe 100, as well as to adjust the fit of shoe 100 when in use by adjusting the tightness of adjustable strap 130. Shoe 100 may also comprise toe strap 140 which may be connected to shoe 100 at the junction of toe portion 115 and mid portion 110 of insole 125. Shoe 100 may further comprise display 155 which may be connected to and form part of sole 120. Shoe 100 may be further equipped with power port 150, which may be located on the back side of sole 120, to allow for connection of shoe 100 with a power and/or information source.

As shown in FIG. 2, display 155 may include messages to be conveyed to a non-user from the user. For example, the letter “U” is displayed as part of a message for communication to a person other than a user. As shown in FIG. 2, the letter “U” is displayed as part of a scrolling message on display 155.

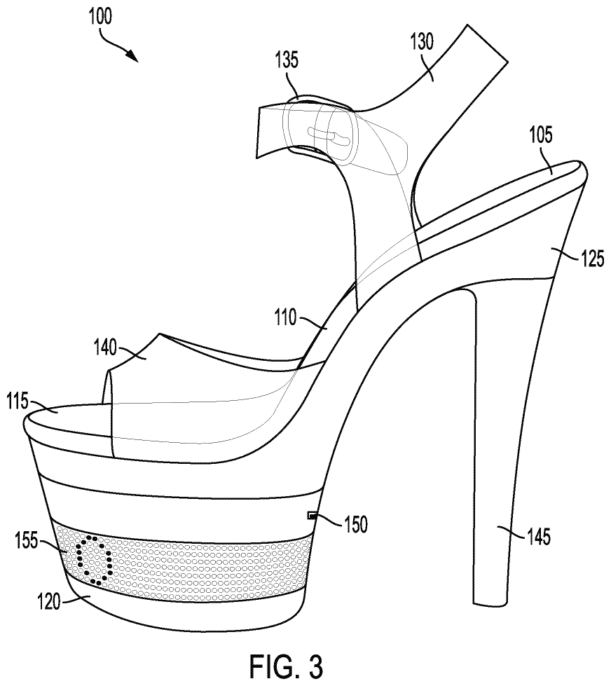

FIG. 3 illustrates a left profile of shoe 100 demonstrating display 155 in use. As discussed above, shoe 100 may be comprised of insole 125 having heel portion 105, mid portion 110, and toe portion 115. Heel portion 105, mid portion 110, and toe portion 115 may form a single piece with heel portion 105 adjacent to mid portion 110 and mid portion 110 adjacent to toe portion 115. Shoe 100 also may have sole 120 connected to toe portion 115 of insole 125 and heel 145 connected to heel portion 105 of insole 125. Shoe 100 may further comprise adjustable strap 130 connected to insole 125 at the junction of heel portion 105 and mid portion 110. Adjustable strap 130 may have buckle 135 attached thereto for allowing adjustable strap 130 to be adjusted and fixed in place. Adjustable strap 130 with buckle 135 may allow a user to put on and remove shoe 100, as well as to adjust the fit of shoe 100 when in use by adjusting the tightness of adjustable strap 130. Shoe 100 may also comprise toe strap 140 which may be connected to shoe 100 at the junction of toe portion 115 and mid portion 110 of insole 125. Shoe 100 may further comprise display 155 which may be connected to and form part of sole 120. Shoe 100 may be further equipped with power port 150, which may be located on the back side of sole 120, to allow for connection of shoe 100 with a power and/or information source.

As shown in FIG. 3, display 155 may include messages to be conveyed to a non-user from the user. For example, the letter “0” is displayed as part of a message for communication to a person other than a user. As shown in FIG. 3, the letter “0” is displayed as part of a scrolling message on display 155.

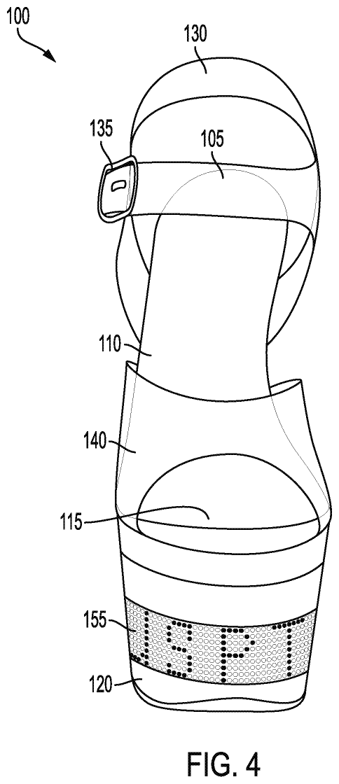

FIG. 4 illustrates a front view of shoe 100 demonstrating display 155 in use. In one embodiment, shoe 100 may be comprised of insole 125 (not shown) having heel portion 105, mid portion 110, and toe portion 115. Heel portion 105, mid portion 110, and toe portion 115 may form a single piece with heel portion 105 adjacent to mid portion 110 and mid portion 110 adjacent to toe portion 115. Shoe 100 also may have sole 120 connected to toe portion 115 of insole 125 and heel 145 (not shown) connected to heel portion 105 of insole 125. Shoe 100 may further comprise adjustable strap 130 connected to insole 125 at the junction of heel portion 105 and mid portion 110. Adjustable strap 130 may have buckle 135 attached thereto for allowing adjustable strap 130 to be adjusted and fixed in place. Adjustable strap 130 with buckle 135 may allow a user to put on and remove shoe 100, as well as to adjust the fit of shoe 100 when in use by adjusting the tightness of adjustable strap 130. Shoe 100 may also comprise toe strap 140 which may be connected to shoe 100 at the junction of toe portion 115 and mid portion 110 of insole 125. Shoe 100 may further comprise display 155 which may be connected to and form part of sole 120. Shoe 100 may be further equipped with power port 150 (not shown), which may be located on the back side of sole 120, to allow for connection of shoe 100 with a power and/or information source.

As shown in FIG. 4, display 155 may include messages to be conveyed to a non-user from the user. For example, a portion of the letter “U” and the letters “SPT” are displayed as part of a message for communication to a person other than a user. As shown in FIG. 4, the letter “USPT” is displayed as part of a scrolling message on display 155.

Display 155 may be programmable to present an image or a scrolling message on display 155. Combining the letters shown on display 155 in FIGS. 2, 3, and 4 the message intended to be conveyed to a non-user from a user is “USPTO.” However, if a user and non-user were in a fixed position relative to one another, the full message would not be conveyed if the message on display 155 were static without a user adjusting the position of shoe 100. With display 155 programmable to present a scrolling message on display 155, the full message may be conveyed to a non-user regardless of their position in space relative to a user wearing shoe 100. Further, the scrolling message may be repeating and continuously scroll the message “USPTO” across display 155.

Display 155 may be programmable to present a moving message in any direction on display 155. In one embodiment, the message “USPTO,” as collectively displayed in FIGS. 2, 3, and 4, may be presented by programming display 155 to move message on display 155 from right to left across display 155 such that each letter is displayed as would be read from left to right in a static message. The message may also be programmed to move on display 155 from left to right, from top to bottom, from bottom to top, diagonally or in other ways that will be apparent to one of ordinary skill in the art. The message may also be programmed to be shown in different ways on display 155, for example a message could be displayed with letters or symbols being upside down or in other ways that will be apparent to one of ordinary skill in the art.

Display 155 may be programmable to present messages in different configurations, orders and/or with varying effects. For example, message “USPTO” may be programmed to move across display 155 in a repeating loop until changed by a user. Another example includes displaying message “USPTO” with other messages in a repeating order and on a loop or in a random order and on a loop. Message “USPTO” could also be programmed to move across display 155 in different directions during a repeating loop, for example, first from right to left, then from left to right, then from top to bottom, then from bottom to top. Further, in some embodiments, the message may be displayed to appear to cross from the display of one shoe to the display of a matching shoe worn by a user on the opposite foot. Display 155 may be programmed to present the message with different effects for example the message may blink, flash, and disappear and reappear in a different or the same location. Different possible combinations of presenting messages on display 155 with varying effects will be apparent to those of ordinary skill in the art.

Display 155 may be programmable to present text or non-text messages. For example, “USPTO” is a message containing text. Messages may be conveyed on display 155 in any language. Messages may also be conveyed using symbols. For example, in place of text a symbol such as a dollar sign, a pound symbol, a picture, an emoji, a video, or other symbols known to those of ordinary skill in the art may be shown on display 155.

Display 155 may also be programmable to synchronize with music. For example, user device 525 may play music or connect with a sound or video system that plays music to which the message shown on display 155 is synchronized. Synchronization may be achieved by linking the varying effects of display 155 with an audio or video file from user device 525.

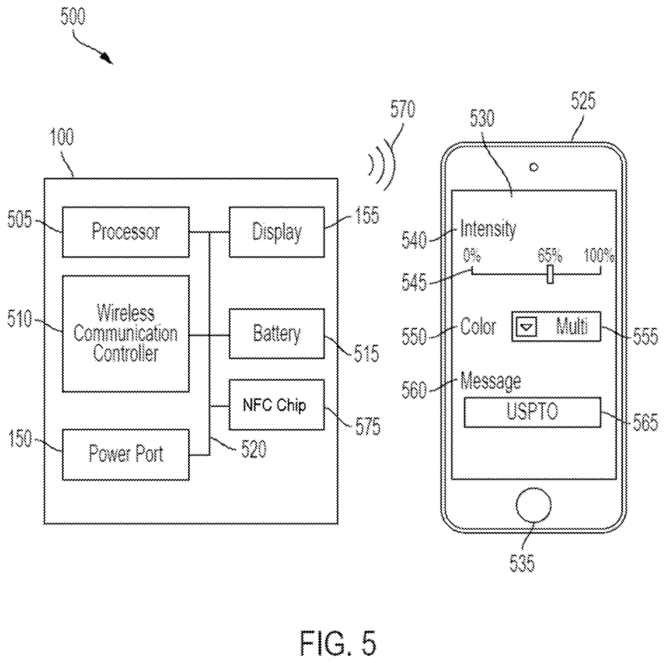

FIG. 5 illustrates a block diagram of a system 500 of shoe 100 with display 155 and an exemplary user device 525. In one embodiment, shoe 100 may contain components including processor 505, display 155, wireless communication controller 510, battery 515, power port 150, near-field communication (“NFC”) chip 575, and main bus 520. Processor 505, display 155, wireless communication controller 510, battery 515, NFC chip 575, and power port 150 may be interconnectable via main bus 520. Shoe 100 may be connectable to user device 525 by wired or wireless connections 570.

In one embodiment, wireless communication controller 510 may include a processor 505 and establish communication with user device 525 by wired or wireless connections 570. Exemplary wired or wireless connections may be implemented using Bluetooth®, Wi-Fi, ZigBee, Z-Wave, RF4CE, Ethernet, telephone line, cellular channels, or others that operate in accordance with protocols defined in IEEE (Institute of Electrical and Electronics Engineers) 802.11, 801.11a, 801.11b, 801.11e, 802.11g, 802.11h, 802.11i, 802.11n, 802.16, 802.16d, 802.16e, the standard formerly known as 802.15.1, or 802.16m using any network type including a wide-area network (“WAN”), a local-area network (“LAN”), a 2G network, a 3G network, a 4G network, a 5G network, a Worldwide Interoperability for Microwave Access (WiMAX) network, a Long Term Evolution (LTE) network, Code-Division Multiple Access (CDMA) network, Wideband CDMA (WCDMA) network, any type of satellite or cellular network, or any other appropriate protocol to facilitate communication known to one of ordinary skill in the art.

In one embodiment, user device 525 may include device display 530 and device control button 535. User device 525 may further include downloadable software, such as an application, for control of shoe 100. Such software may allow a user to control various message presentation details of display 155 within shoe 100, for example, the intensity and/or color of the lights and the content of the message on display 155. These message presentation details of display 155 may be presented to a user on device display 530 for a user to adjust the message intended to be communicated via display 155. For example, intensity banner 540 may be displayed with intensity selector 545, color banner 550 may be displayed with color selector 555, and message banner 560 may be displayed with message selector 565 on device display 530. It is noted that display 530 of user device 525 may provide additional options to a user, such as uploading an image for display along with controls about display characteristics of that image. A user may have access to individual pixels to create custom designs or images by manipulating a color and intensity of light of a certain LED or pixel in the display.

User device 525 may be a computing device that includes a processor. User device 525 may be implemented as a smart phone, a tablet, a laptop computer, a desktop computer, a music storage and playback device, a personal digital assistant, or any other device incorporating a processor which is capable of implementing a software application that may interact with, control, and provide information to shoe 100, for example, via the Internet with any of the exemplary wired or wireless connections discussed herein. User device 525 may include software and hardware modules, sequences of instructions, routines, data structures, display interfaces, and other types of structures that execute computer operations. Further, hardware components may include a combination of Central Processing Units (“CPUs”), buses, volatile and non-volatile memory devices, storage units, non-transitory computer-readable storage media, data processors, processing devices, control devices transmitters, receivers, antennas, transceivers, input devices, output devices, network interface devices, and other types of components that are apparent to those skilled in the art. These hardware components within user device 525 may be used to execute the various methods or algorithms disclosed herein independent of or in coordination with other devices disclosed herein.

The software input selectors, such as intensity selector 545, color selector 555, and message selector 565, as displayed on device display 530 may be used by the user to customize the message, appearance, and behavior of the message on display 155. Each input selector may be one of a variety of selection controls, for example sliders, checkboxes, switches, scroll wheels, text input fields, or other selection controls that will be apparent to one of ordinary skill in the art. Further, selection controls may be available for additional features such as whether the message on display 155 may be static or moving, and the direction or speed of the displayed message when moving. Other customizable message features will be apparent to those of ordinary skill in the art.

In implementation, a user may wish to convey a message on display 155. A user may access processor 505 through user device 525 to input a message and message presentation details. For example, a user may wish to present “USPTO” on display 155 with multiple colors and at an intensity of 65%. A user may access the downloaded software application on device display 530 after accessing device through device control button 535. Once the software application is available to the user on device display 530 the user may navigate to intensity banner 540. A user may then use intensity selector 545 to adjust the intensity of the display 155 lights to 65%. A user may then navigate to color banner 550 and use color selector 555 to choose the appropriate color setting, in this case for example, “multi,” for multiple colors. A user may then navigate to message banner 560 and use message selector 565 to input the text message “USPTO.” A user may also wish to modify other customizable message features, for example whether the message on display 155 may be static or moving, and the direction or speed of the displayed message when moving.

Once the user has selected all the desired customizable message features, the user may then send the input information to processor 505 through wireless connection 570, which may be, for example, a Bluetooth connection. The information may then be received by wireless communication controller 510. Once wireless communication controller 510 receives the message input data from user device 525, wireless communication controller 510 may then convey the message data to processor 505 through main bus 520. Processor 505 may then send the message information to display 155 through main bus 520. The user's message may then be shown on display 155 for communication to the user's audience according to the message details selected by the user on user device 525. The user may then change the message as desired to display any message desired at any time.

Battery 515 may be recharged by the user as necessary to continue to display messages. Certain components of shoe 100, for example processor 505, wireless communication controller 510, NFC chip 575, and display 155 may be powered by battery 515 through main bus 520. Once battery 515 has been discharged, battery 515 may be recharged by the user. To recharge battery 515, the user may connect a power source to shoe 100 through power port 150. Power port 150 allows power to flow from power source to battery 515 through main bus 520.

In one embodiment, via NFC chip 575, a user may send or receive payments and share or receive data such as contact information, social media data, etc. For example, a user may connect applications on user device 525 to NFC chip 575 of shoe 100, such as payment applications, social media applications, and other applications known to a person having ordinary skill in the art. In this manner, a user may send or receive payments or other electronic data to or from a third party, such as a customer or friend having a mobile or other electronic device capable of communicating with NFC chip 575 in exchange for a service, a delivery of goods, or as a way of otherwise transferring electronic data. Further, NFC chip 575 may be used for sharing or acquiring information regarding shoe 100, or information regarding goods or services associated with or provided by a user of shoe 100.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments. For example, components described herein may be removed and other components added without departing from the scope or spirit of the embodiments disclosed herein or the appended claims.

Other embodiments will be apparent to those skilled in the art from consideration of the specification and practice of the disclosure disclosed herein. It is intended that the specification and examples be considered as exemplary only, with a true scope and spirit of the invention being indicated by the following claims.

What is claimed is:

1. A wearable display device comprising:
a shoe, the shoe having a display screen installed therein, and
a processor, including a memory, installed in the shoe for providing instructions to the display screen.

2. The wearable display device of claim 1, further comprising a near-field communication (“NFC”) chip installed in the shoe.

3. The wearable display device of claim 1 wherein the display screen is installed in a sole of the shoe.

4. The wearable display device of claim 1 wherein the display screen is installed in an upper of the shoe.

5. The wearable display device of claim 1 wherein the display screen is at least one of an LED display and a plasma display.

6. The wearable display device of claim 1 further comprising at least a second display screen installed in the shoe.

7. The wearable display device of claim 1 wherein the display screen displays at a minimum definition of standard definition (480p) and has a minimum refresh rate of 60 Hz.

8. The wearable display device of claim 1 wherein the display screen is flexible.

9. The wearable display device of claim 1 wherein the display screen is at least one of water-resistant and waterproof.

10. The wearable display device of claim 1 wherein the device displays a scrolling message on the display screen.

11. A system comprising,
a wearable display device comprising:
a shoe, the shoe having a display screen installed therein, and a processor, including a memory, installed in the shoe for providing instructions to the display screen; and
a user device connectable to the wearable display device through wired or wireless connections.

12. The system of claim 11, wherein the wearable display device further comprises a near-field communication (“NFC”) chip installed in the shoe.

13. The system of claim 11 wherein the display screen is installed in a sole of the shoe.

14. The system of claim 11 wherein the display screen is installed in an upper of the shoe.

15. The system of claim 11 wherein the display screen is at least one of an LED display and a plasma display.

16. The system of claim 11 further comprising at least a second display screen installed in the shoe.

17. The system of claim 11 wherein the display screen displays at a minimum definition of standard definition (480p) and has a minimum refresh rate of 60 Hz.

18. The system of claim 11 wherein the display screen is flexible.

19. The system of claim 11 wherein the display screen is at least one of water-resistant and waterproof.

20. The system of claim 11 wherein the device displays a scrolling message on the display screen.
